(19) United States
(12) Patent Application Publication
(10) Pub. No.: US 2017/0192138 A1
(43) Pub. Date: Jul. 6, 2017

(54) REFLECTING FACE MASK AND LED DISPLAY DEVICE HAVING THE SAME

(71) Applicant: LEYARD OPTOELECTRONIC CO., LTD., Beijing (CN)

(72) Inventor: Ming CHANG, Beijing (CN)

(21) Appl. No.: 15/247,223

(22) Filed: Aug. 25, 2016

(30) Foreign Application Priority Data
Jan. 6, 2016 (CN) 201610009097.1

(51) Int. Cl. G02B 5/02

(52) U.S. Cl. CPC G02B 5/0284; G02B 5/021

(57) ABSTRACT

The invention provides a reflecting face mask and a Light-Emitting Diode display device having the same. The reflecting face mask includes a face mask unit, the face mask unit includes: a top plate, the top plate is a flat plate, an inner surface of the top plate is a reflecting surface, an outer surface of the top plate is a diffuse reflecting surface; and two first side plates, provided oppositely and connected with the top plate respectively, a size of a first end of each of the first side plates is greater than that of a second end of the first side plate to make the top plate provided obliquely, a light gap is formed between the first ends of the two first side plates. The technical solution of the invention effectively solves the problem in the traditional art that a feeling of viewing an LED display screen is bad.

### TECHNICAL FIELD OF THE INVENTION

The invention relates to the technical field of displays, and in particular to a reflecting face mask and a Light-Emitting Diode (LED) display device having the same.

### BACKGROUND OF THE INVENTION

As shown in FIG. 1, light emitted by LED lamps 1 of a traditional LED display screen directly enters eyes of an audience 4 without passing through any media. In order to improve the contrast ratio of a display picture of the display screen, a black plastic face mask 2 will be filled between two LED lamps 1. In this case, a severe light intensity contrast, namely a glare phenomenon, exists between high-bright light of the LED lamps 1 and the black face mask 2.

As shown in FIG. 2, in the prior art, an atomizing face mask 3 made from transparent plastic is mounted on a surface of the traditional LED display screen. Each LED lamp 1 is separately provided in a small box. In such a way, light emitted by the LED lamps 1 is directly emitted to the atomizing face mask 3 and then enters the eyes of the audience 4 through a frosted surface of plastic. According to the method, direct light enters human eyes. The effect of the method is not ideal.

### SUMMARY OF THE INVENTION

A main objective of the invention is to provide a reflecting face mask and an LED display device having same, which are intended to solve the problem in the traditional art that a feeling of viewing an LED display screen is bad.

To this end, according to one aspect of the invention, a reflecting face mask is provided, which may comprise: a face mask unit, wherein the face mask unit comprises: a top plate, the top plate is a flat plate, an inner surface of the top plate is a reflecting surface, an outer surface of the top plate is a diffuse reflecting surface; and two first side plates, provided oppositely and connected with the top plate respectively, a size of a first end of each of the first side plates is greater than that of a second end of the first side plate to make the top plate provided obliquely, a light emergence gap is formed between the first ends of the two first side plates.

Furthermore, the face mask unit may further comprise a partition plate which is provided between the two first side plates so as to partition the light emergence gap into multiple sub-outlets.

Furthermore, there may be multiple face mask units which are arranged in multiple rows, and the first ends of the two first side plates of one of two adjacent face mask units are adjacent to the second ends of the two first side plates of the other face mask unit.

Furthermore, the multiple face mask units are of an integrated structure.

Furthermore, the face mask unit further comprise a second side plate, the second side plate is connected between the second ends of the two first side plates.

Furthermore, the outer surface of the top plate is white.

Furthermore, a chromium-plated layer is provided on the inner surface of the top plate.

Furthermore, the face mask unit further comprise a shielding plate, and the shielding plate comprise first shielding plates, the first shielding plates are provided on the outer surface of the top plate and corresponding to the two first side plates in position.

Furthermore, the shielding plate further comprises a second shielding plate, the second shielding plate is provided on the outer surface of the top plate and corresponds to the partition plate in position.

According to another aspect of the invention, an LED display device is provided, which may comprise a face plate, provided with LED lamp beads, and a reflecting face mask. The reflecting face mask is the above reflecting face mask, and the reflecting face mask covers the face plate.

Furthermore, a reflecting plating layer is provided on the face plate.

By applying the technical solution of the invention, a face mask unit covers LED lamp beads, light emitted by the LED lamp beads is emitted to an inner surface of a top plate, the inner surface of the top plate reflects the light of the LED lamp beads to an outer surface of another face mask unit, and the outer surface forms diffuse reflection of the light reflected by the inner surface. In such a way, the light of the LED lamp beads is evenly scattered, and the light received by an audience is soft and even light. The structure improves a feeling of viewing an LED display screen by the audience.

### BRIEF DESCRIPTION OF THE DRAWINGS

The drawings of the specification, forming a part of the invention, are used to provide further understanding of the invention. The schematic embodiments and illustrations of the invention are used to explain the invention, and do not form improper limits to the invention. In the drawings:

FIG. 1 shows a structural diagram of an embodiment for an LED display device with a black face mask in the prior art;

FIG. 2 shows a structural diagram of an embodiment for an LED display device with an atomizing face mask in the prior art;

FIG. 3 shows a space diagram of an embodiment for an LED display device according to the invention;

FIG. 4 shows a side view of an LED display device in FIG. 3;

FIG. 5 shows another angle diagram of an LED display device in FIG. 3;

FIG. 6 shows a sectional view of an LED display device in FIG. 3; and

FIG. 7 shows a light path direction diagram of an LED display device in FIG. 3.

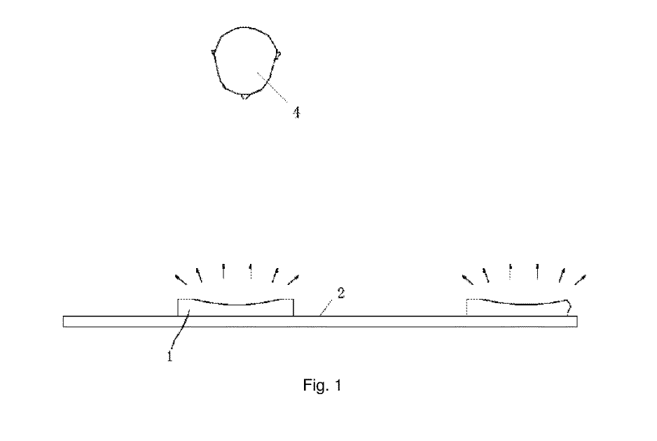

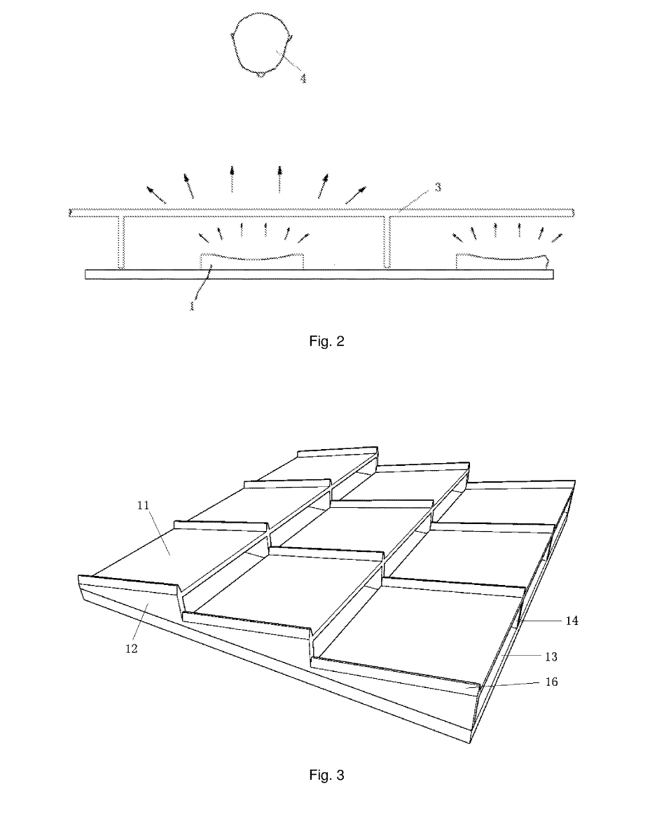

Wherein, the drawings comprise the following drawing marks:

1, LED lamp; 2, black plastic face mask; 3, atomizing face mask; 4, audience; 10, face mask unit; 11, top plate; 12, first side plate; 13, light emergence gap; 14, partition plate; 15, second side plate; 16, shielding plate; 20, LED lamp bead; 30, face plate; 100, first region; and 200, second region.

### DETAILED DESCRIPTION OF THE EMBODIMENTS

It is important to note that the embodiments of the invention and the characteristics in the embodiments can be combined under the condition of no conflicts. The invention will be illustrated below with reference to the drawings and the embodiments in detail.

As shown in FIG. 3 to FIG. 5, a reflecting face mask of the present embodiment comprises: a face mask unit 10. The face mask unit 10 comprises: a top plate 11 and two first side plates 12. The top plate 11 is flat, an inner surface of the top plate 11 is a reflecting surface, and an outer surface of the top plate 11 is a diffuse reflecting surface. The two first side plates 12 are provided oppositely and connected with the top plate 11 respectively, a size of a first end of each of the first side plates 12 is greater than that of a second end of the first side plate 12 to make the top plate 11 provided obliquely, and a light emergence gap 13 is formed between the first ends of the two first side plates 12.

By applying the technical solution of the present embodiment, the face mask unit covers LED lamp beads, light emitted by the LED lamp beads is emitted to an inner surface of the top plate 11, the inner surface of the top plate 11 reflects the light of the LED lamp beads to an outer surface of another face mask unit, and the outer surface forms diffuse reflection of the light reflected by the inner surface. In such a way, the light of the LED lamp beads is evenly scattered, and the light received by an audience is soft and even light. The structure improves a feeling of viewing an LED display screen by the audience.

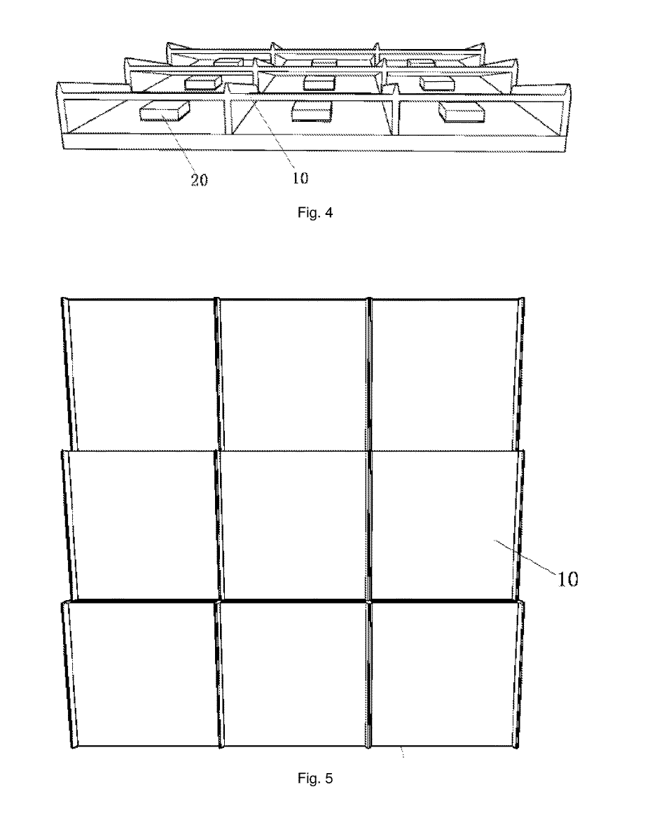

As shown in FIG. 3 and FIG. 4, in the technical solution of the present embodiment, the face mask unit 10 further comprises a partition plate 14 which is provided between the two first side plates 12 so as to partition the light emergence gap 13 into multiple sub-outlets. The structure improves, on one hand, the strength of the face mask unit, and enables, on the other hand, the face mask unit 10 to divide the LED display screen into different units, thereby avoiding mutual interference of light emitted by all small units in the LED display screen. Specifically, the face mask unit 10 provides the partition plates 14 according to the number of the LED lamp beads. Further specifically, the outer surface of the top plate is white. The light emergence gap 13 is a rectangular opening.

As shown in FIG. 3 to FIG. 5, in the technical solution of the present embodiment, there are multiple face mask units 10 which are provided in multiple rows, and the first ends of the two first side plates 12 of one of two adjacent face mask units 10 are adjacent to the second ends of the two first side plates 12 of the other face mask unit 10. The structure ensures that light emitted by the LED lamp beads is reflected by the inner surface and then reflected to the outer surface of the adjacent the other face mask unit 10 through the light emergence gap 13. In such a way, the layout between the face mask units 10 is compact, and the viewing effect is good. Specifically, the multiple face mask units 10 are of an integrated structure. The structure is easy to machine.

As shown in FIG. 3 to FIG. 7, in the technical solution of the present embodiment, the face mask unit 10 further comprises a second side plate 15, and the second side plate 15 is connected between the second ends of the two first side plates 12. When the first side plates are trapezoidal, the structure of providing the second side plate 15 at the second ends of the two first side plates 12 ensures that light will not leak from the face mask unit 10.

In the technical solution of the present embodiment (not shown in the figure), a chromium-plated layer is provided on the inner surface of the top plate 11. The structure is easy to machine and manufacture, good in reflecting effect, and lower in cost.

As shown in FIG. 3 to FIG. 5, in the technical solution of the present embodiment, the face mask unit 10 further comprises a shielding plate 16, the shielding plate 16 comprises first shielding plates, and the first shielding plates are disposed on the outer surface of the top plate 11 and correspond to the two first side plates 12 in position. Furthermore, the shielding plate 16 further comprises a second shielding plate, and the second shielding plate is provided on the outer surface of the top plate 11 and corresponds to the partition plate 14 in position. The structure ensures that light reflected by the outer surface of the face mask unit 10 cannot mutually interfere.

The invention also provides an LED display device. The LED display device according to the invention comprises a face plate 30, provided with LED lamp beads 20, and a reflecting face mask. The reflecting face mask is the above reflecting face mask, and the reflecting face mask covers the face plate 30. The LED display device with the structure has a good feeling of viewing.

A reflecting plating layer is provided on the face plate 30 of the invention. Thus, the strength of light can be improved, and the loss of light is reduced.

The technical solution of the invention not only can improve the feeling of viewing by avoiding direct light, but also has an effect of 100% pixel filling rate, namely avoids glare. The area of a diffuse reflecting surface on a face mask is larger, so that each pixel exclusively has a reflecting surface, and the size thereof is a square value of an interval between pixels basically. The size of an LED lamp of a prior LED screen is small, and the ratio of the light-emitting area to the total area is small, which is about 10% to 30% usually, so a glare phenomenon will be caused. A P4 (4mm pixel interval) LED display device is taken as an example below.

The size of an LED lamp bead is 1.6 mm×1.6 mm, a pixel filling rate of an LED lamp bead of a traditional display screen is S1, an LED pixel filling rate of the invention is S2, and they are calculated as follows.

S1=1.6*1.6/4*4=16%; and

S2=4*4/4*4=100%.

A great pixel filling rate brings a qualitative leap to a feeling of viewing.

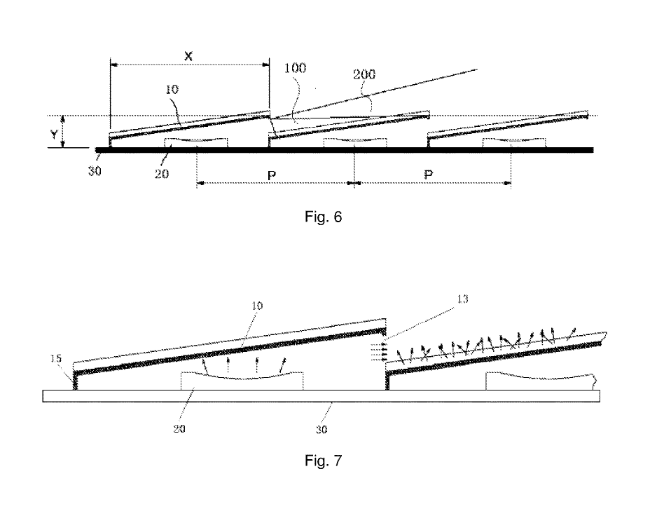

Based on an interpretation on an LED emergence light path of the invention, as shown in FIG. 6 and FIG. 7, an LED pixel interval is P, the thickness of the face mask of the invention is Y, and the height of a single face mask is X. The pre-determined serial number of a reflecting face mask above a certain LED lamp bead is N, after being emitted, light is diffusely reflected on the N+1^{th} reflecting face mask, and when being located in a first region 100, light reflected by an inner surface of the reflecting face mask can participate in diffuse reflection; and when being located in a second region 200, light reflected by the inner surface of the reflecting face mask cannot participate in diffuse reflection and cannot be projected to the N+2^{th} reflecting face mask.

The above is only the preferred embodiments of the invention, and is not used to limit the invention. There can be various modifications and variations in the invention for those skilled in the art. Any modifications, equivalent replacements, improvements and the like within the spirit and principle of the invention shall fall within the protective scope of the invention.

1. A reflecting face mask, comprising: a face mask unit (10), the face mask unit (10) comprises:
a top plate (11), the top plate (11) is a flat plate, an inner surface of the top plate (11) is a reflecting surface, an outer surface of the top plate (11) is a diffuse reflecting surface; and
two first side plates (12), provided oppositely and connected with the top plate (11) respectively, a size of a first end of each of the first side plates (12) is greater than that of a second end of the first side plate (12) to make the top plate (11) provided obliquely, a light emergence gap (13) is formed between the first ends of the two first side plates (12).

2. The reflecting face mask according to claim 1, wherein the face mask unit (10) further comprises a partition plate (14) which is provided between the two first side plates (12) so as to partition the light emergence gap (13) into multiple sub-outlets.

3. The reflecting face mask according to claim 2, wherein there are multiple face mask units (10) which are arranged in multiple rows, and the first ends of the two first side plates (12) of one of two adjacent face mask units (10) are adjacent to the second ends of the two first side plates (12) of the other face mask unit (10).

4. The reflecting face mask according to claim 3, wherein the multiple face mask units (10) are of an integrated structure.

5. The reflecting face mask according to claim 2, wherein the face mask unit (10) further comprises a second side plate (15), the second side plate (15) is connected between the second ends of the two first side plates (12).

6. The reflecting face mask according to claim 5, wherein the outer surface of the top plate (11) is white.

7. The reflecting face mask according to claim 5, wherein a chromium-plated layer is provided on the inner surface of the top plate (11).

8. The reflecting face mask according to claim 5, wherein the face mask unit (10) further comprises a shielding plate (16), and the shielding plate (16) comprises first shielding plates, the first shielding plates are provided on the outer surface of the top plate (11) and correspond to the two first side plates (12) in position.

9. The reflecting face mask according to claim 8, wherein the shielding plate (16) further comprises a second shielding plate, the second shielding plate is provided on the outer surface of the top plate (11) and corresponds to the partition plate (14) in position.

10. A Light-Emitting Diode (LED) display device, comprising a face plate (30), provided with LED lamp beads (20), and a reflecting face mask, wherein the reflecting face mask is the reflecting face mask according to claim 1, and the reflecting face mask covers the face plate (30).

11. The LED display device according to claim 10, wherein a reflecting plating layer is provided on the face plate (30).

12. A Light-Emitting Diode (LED) display device, comprising a face plate (30), provided with LED lamp beads (20), and a reflecting face mask, wherein the reflecting face mask is the reflecting face mask according to claim 2, and the reflecting face mask covers the face plate (30).

13. A Light-Emitting Diode (LED) display device, comprising a face plate (30), provided with LED lamp beads (20), and a reflecting face mask, wherein the reflecting face mask is the reflecting face mask according to claim 3, and the reflecting face mask covers the face plate (30).

14. A Light-Emitting Diode (LED) display device, comprising a face plate (30), provided with LED lamp beads (20), and a reflecting face mask, wherein the reflecting face mask is the reflecting face mask according to claim 4, and the reflecting face mask covers the face plate (30).

15. A Light-Emitting Diode (LED) display device, comprising a face plate (30), provided with LED lamp beads (20), and a reflecting face mask, wherein the reflecting face mask is the reflecting face mask according to claim 5, and the reflecting face mask covers the face plate (30).

16. A Light-Emitting Diode (LED) display device, comprising a face plate (30), provided with LED lamp beads (20), and a reflecting face mask, wherein the reflecting face mask is the reflecting face mask according to claim 6, and the reflecting face mask covers the face plate (30).

17. A Light-Emitting Diode (LED) display device, comprising a face plate (30), provided with LED lamp beads (20), and a reflecting face mask, wherein the reflecting face mask is the reflecting face mask according to claim 7, and the reflecting face mask covers the face plate (30).

18. A Light-Emitting Diode (LED) display device, comprising a face plate (30), provided with LED lamp beads (20), and a reflecting face mask, wherein the reflecting face mask is the reflecting face mask according to claim 8, and the reflecting face mask covers the face plate (30).

19. A Light-Emitting Diode (LED) display device, comprising a face plate (30), provided with LED lamp beads (20), and a reflecting face mask, wherein the reflecting face mask is the reflecting face mask according to claim 9, and the reflecting face mask covers the face plate (30).
